(19) United States
(12) Patent Application Publication
(10) Pub. No.: US 2010/0076105 A1
(43) Pub. Date: Mar. 25, 2010

(54) MONODISPERSE THERMO-RESPONSIVE MICROGELS OF POLY(ETHYLENE GLYCOL) ANALOGUE-BASED BIOPOLYMERS, THEIR MANUFACTURE, AND THEIR APPLICATIONS

(75) Inventors: Zhibing Hu, Denton, TX (US); Tong Cai, Savannah, TX (US); Chenglin Chi, Ennis, TX (US); Manuel Marquez, Midlothian, VA (US)

Correspondence Address: JACKSON WALKER LLP, 901 MAIN STREET, SUITE 6000, DALLAS, TX, 75202-3797, US

(73) Assignee: University of North Texas, Denton, TX (US)

(21) Appl. No.: 12/502,842

(22) Filed: Jul. 14, 2009

Related U.S. Application Data
(60) Provisional application No. 61/135,318, filed on Jul. 18, 2008.

(51) Int. Cl. C08L 33/10; C08F 2/48

(52) U.S. Cl. 522/33; 524/523

(57) ABSTRACT

Composition, processes, techniques, and apparatus for synthesizing monodisperse microgels based on poly(ethylene glycol) (PEG) derivative polymers by using precipitation polymerization. These microgels are hydrophilic and have the adjustable volume phase transition temperature in aqueous environment. Microgels can be added with various functional groups. These microgels in water can self-assemble into various phases, including a crystalline phase. Hydrogel films with iridescent colors were formed using these microgels as crosslinkers to connect poly(ethylene glycol) chains. The colors of these hydrogel films change with changes of environment such temperature, pH, salt concentration, etc.

### PRIORITY CLAIM

This application claims priority to U.S. Provisional Patent Application Ser. No. 61/135,318, entitled “MONODISPERSE THERMO-RESPONSIVE MICROGELS OF POLY(ETHYLENE GLYCOL) ANALOGUE-BASED BIOPOLYMERS, THEIR MANUFACTURE, AND THEIR APPLICATIONS” filed on Jul. 18, 2008, the entire content of which is hereby incorporated by reference.

### STATEMENT OF RIGHTS TO INVENTIONS MADE UNDER FEDERALLY SPONSORED RESEARCH

This invention was made in part during work supported by a grant from the National Science Foundation (DMR-0507208), to Zhibing Hu, entitled “Novel polymer microgel dispersions with an inverse thermoreversible gelation”. The government may have certain rights in the invention.

### FIELD OF THE INVENTION

The present invention relates to composition, processes, techniques, and apparatus for synthesizing monodisperse microgels using a precipitation polymerization method. These non-toxic and anti-immunogenic microgels are applicable to controlled drug delivery and other biomedical applications.

### BACKGROUND

Poly-N-isopropylacrylamide (PNIAPM) is one of the most studied thermo-responsive polymers with a lower critical solution temperature (LCST) at 32° C.[1] Free radical polymerization of NIPAM monomer under various conditions has been used to produce polymer, bulk gel, microgel (or nanoparticle).[2] At room temperature, PNIAPM gel is in a swollen state and at body temperature it changes into a collapsed state. This change is due to an entropy effect, resulting from a balance between hydrogen-bond formation with water and intramolecular hydrophobic forces.[3] The combination of the sharp transition and easy accessible, tunable LCST near the body temperature has made PNIPAM very attractive for both scientific studies and technological applications. Specifically, PNIPAM gels and their derivatives have been intensively studied and were found very promising for pulsatile drug delivery.[4-9] However, the extraordinary thermo-sensitive properties of PNIPAM have not been transferred into a biomedical breakthrough in controlled drug delivery devices for human body. The major hurdle is that NIPAM monomer is carcinogenic or teratogenic.[10] Recently, Lutz, et al have reported that that copolymers of 2-(2-methoxyethoxy)ethyl methacrylate and oligo(ethylene glycol) methacrylate (P(MEO₂MA-co-OEGMA)) exhibit a thermoresponsive behavior generally comparable, and in some cases, superior to PNIPAM.[11-13] The present invention relates to microgels of P(MEO₂MA-co-OEGMA) which have been synthesized using free radical polymerization. The microgels with a variety of particle radii have been obtained with different surfactant concentrations. The particle size distribution is extremely narrow and even better than PNIPAM microgels. The new P(MEO₂MA-co-OEGMA) microgels show thermo-reversible volume phase transition near the LCST and can easily self-assemble into crystalline structures, similar to PNIPAM microgels.[14-18] Considering that PEG is nontoxic and anti-immunogenic and has been approved by the FDA [11-13, 19-20], thermo-responsive P(MEO₂MA-co-OEGMA) microgels may lead to many biomedical applications.

### SUMMARY

The present invention comprises 1) The processes, techniques and apparatus for synthesizing of monodisperse microgels of poly(ethylene glycol) analogues-based polymers by using precipitation polymerization method. The microgels with a variety of particle radii ranging from 82 nm to 412 nm have been obtained with different surfactant concentrations. The LCST corresponding to the molar ratio of oligo(ethylene glycol) methacrylate (OEGMA) to 2-(2-methoxyethoxy)ethyl methacrylate (MEO₂MA) at 10 and 20% are 31 and 37° C., respectively. 2) The microgels in water self-assemble into various phases including a crystalline structure with iridescent colors, which are the result of Bragg diffraction from different oriented crystalline planes. 3) The crystal structures of microgels can be made permanent by either covalently bonding neighboring particles or entrapping microgels into another hydrogel matrix. 4) Considering that PEG is nontoxic and anti-immunogenic and has been approved by the FDA, thermo-responsive PEG-based microgels may lead to many biomedical applications including controlled drug delivery.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows: (a) Hydrodynamic radius distributions (f(Rh)) of P(MEO₂MA-co-OEGMA(475)) microgels in deionized water at 18° C. The microgels were synthesized with different surfactant concentrations of SDS (0 g, batch 4), (0.02 g, batch 5), (0.04 g, batch 2), (0.06 g, batch 6), and (0.08, batch 7). (b) Hydrodynamic radius distributions of a typical PNIPAM microgel and the P(MEO₂MA-co-OEGMA(475)) microgel (batch 5) in are compared. The scattering angle is 60°;

FIG. 2 shows: (a) Temperature dependent normalized hydrodynamic radius (Rₕ(T)/Rₕ(18° C.)) of P(MEO₂MA-co-OEGMA(475)) microgels with different molar ratio of OEGMA to MEO₂MA: 0 (squares), 10% (triangles), and 20% (circles). Brown hexagons are for PNIPAM microgels. (b) Temperature dependent normalized hydrodynamic radius (Rₕ(T)/Rₕ(18° C.)) of P(MEO₂MA-co-OEGMA) microgels with different OEGMA molecular weight: 0 (squares), 300 (triangles) and 475 (circles);

FIG. 3 shows: (a) Photographs of aqueous dispersions of P(MEO₂MA-co-OEGMA(475)) microgels (batch 2) with different polymer concentrations at 18° C.: a) 4.3, b) 4.8, c) 5.2, d) 6.5, e) 6.9, f) 7.8, and g) 10.2 wt %. (b) Phase diagram: the volume phase transition (T_{c}, dashed line) of the P(MEO₂MA-co-OEGMA(475)) microgel, melting temperature (Tₘ, open squares), and the glass-transition temperature (T_{g}, open circles) are denoted;

FIG. 4 shows: (a) Photographs of P(MEO₂MA-co-OEGMA(475)) (batch 2) microgel crystal dispersions at various polymer concentrations a) 4.8, b) 5.2, c) 6.1, d) 7.8, and e) 10.2 wt %. Each microgel dispersion was heated to above its melting point and then allowed to cool naturally to 18° C. (b) UV-visible spectra of P(MEO₂MA-co-OEGMA(475)) microgels crystals. The Bragg diffraction peak shifts to lower wavelength as the polymer concentration increases. From left to right: 10.2, 7.8, 6.1, 5.2, and 4.8 wt %;

FIG. 5 shows: A hydrogel thin film that PEG derivative microgels were used as crosslinkers to connect PEG chains. Gel color changes with temperatures at: a) 22° C., b) 24° C., c) 30° C., d) 34° C., e) 40° C., and f) 50° C.;

FIG. 6 shows: The crystalline hydrogel at 21° C. displays a bright red color but chances from red to green at 50° C.;

FIG. 7 shows: (a) Turbidity versus wavelength measured with a UV-Visible spectrophotometer for a hydrogel thin film consisting of PEG derivative microgels and plyacylamide chains. The Bragg diffraction peak shifts to lower wavelengths as the temperature increases. (b) The relationship between the wavelength of Bragg peak and the temperature of the hydrogel thin films composed with either PEG microgels and PEG chains (blue line and squares) or PEG microgels and polyacrylamide chains (black line and squares);

FIG. 8 shows: A typical hydrogel thin film that P(MEO₂MA-co-OEGMA) microgels were trapped into a PEG hydrogel matrix; and

FIG. 9 shows: (a) PEG derivative microgels were attached with vinyl groups. (b) Vinyl PEG derivative particles as crosslinkers to connect PEG or other polymer chains together under UV irradiation. (c) The resultant hydrogel consists of a PEG particle crystalline array that diffracts light and PEG polymer chains that fix the particle array. Where green spheres represent PEG particles, brown spheres vinyl group and curved lined polymer chains.

### DETAILED DESCRIPTION OF PREFERRED EMBODIMENTS

The present invention relates to composition, processes, techniques, and apparatus for synthesizing monodisperse microgels based on poly(ethylene glycol) (PEG) derivative polymers by using precipitation polymerization. These microgels are hydrophilic and have the adjustable volume phase transition temperature in aqueous environment. Microgels can be added with various functional groups. These microgels in water can self-assemble into various phases, including a crystalline phase. Hydrogel films with iridescent colors were formed using these microgels as crosslinkers to connect poly(ethylene glycol) chains. The colors of these hydrogel films change with changes of environment such temperature, pH, salt concentration, etc.

### 1. Materials

2-(2-Methoxyethoxy)ethyl methacrylate (MEO₂MA 95%), poly(ethylene glycol) methyl ether methacrylate (OEGMA 475 Mn=475 g mol-1), poly(ethylene glycol) methyl ether methacrylate (OEGMA 300 Mn=300 g mol-1), dodecyl sulfate sodium salt 98% (SDS), potassium persulfate (KPS) were purchased from Aldrich. Ethylene glycol dimethacrylate (EGDMA 97%) was purchased from Fluka. Water for sample preparation was distilled and deionized to a resistance of 18.2 MW by a Millipore system and filtered through a 0.22 μm filter to remove particulate matter.

### 2. Copolymerization of MEO₂MA and OEGMA Microgel Preparation.

The copolymerization of MEO2MA and OEGMA was carried out in a three neck flask equipped with a magnetic stirrer and a nitrogen feed (Table 1): 0.016 mol of MEO2MA, different moles and molecular weights of OEGMA, 4.6×10−4 mol EGDMA, different concentrations of SDS were dissolved in 245 g deionized water. The solution was purged with nitrogen gas for 40 minutes at 70° C. Potassium persulfate (0.10 g), which was dissolved in 5 mL of water, was then added to initiate the emulsion copolymerization. The reaction lasted for 6 hours under nitrogen atmosphere. The reaction temperature was kept at 70+0.5° C. All copolymerization of MEO2MA and OEGMA microgels were purified via dialysis tube (MWCO 13 000) against frequent changes of stirring water for 1 weeks at room temperature. The final microgels were collected by centrifuge.

Dynamic Light Scattering Characterization. A laser light scattering spectrometer (ALV, Germany) equipped with an ALV-5000 digital time correlator was used with a helium-neon laser (Uniphase 1145P, output power of 22 mW and wavelength of 632.8 nm) as the light source. The hydrodynamic radius distribution of the microgels in water was measured at a scattering angle of 60°.

UV-Visible Spectroscopy Measurements. The turbidity (a) of the gels was measured as a function of the wavelength using a diode array UV-visible spectrometer (Agilent 8453) by calculating the ratio of the transmitted light intensity (Iₜ) to the incident intensity (I₀) a=−(1/d)ln(Iₜ/I₀), where d is the thickness (1 mm) of the sampling cuvette.

### 3. Synthesis and Characterization of Microgels

### 3.1. (MEO₂MA-co-OEGMA) Microgels

The free radical copolymerization of MEO₂MA and OEGMA was carried out in a three neck flask equipped with a magnetic stirrer and a nitrogen feed. Typically, 0.016 mol of MEO₂MA, different moles and molecular weights of OEGMA, 4.6×10₋₄ mol EGDMA as a crosslinker, different concentrations of SDS as surfactant were dissolved in 245 g dionized and distilled water. The solution was purged with nitrogen gas for 40 minutes at 70° C. Potassium persulfate (0.10 g), which was dissolved in 5 mL of water, was then added to initiate polymerization. The reaction lasted for 6 hours under a nitrogen atmosphere at 70° C. The resulting P(MEO₂MA-co-OEGMA) microgels were purified via dialysis tube (MWCO 13,000) against frequent changes of stirring water for one week at room temperature. The final microgels were collected by an ultracentrifuge.

The average hydrodynamic radius (Rₕ) and the radius distribution function, f(Rₕ), of these microgels were characterized using a laser light scattering spectrometer (ALV Co., Germany). The dynamic light scattering experiments were performed at the scattering angle è=60°.

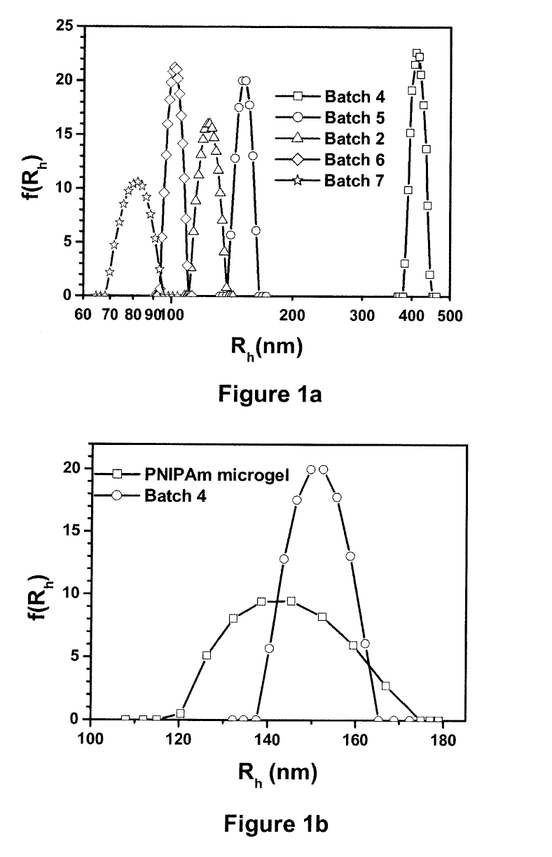

FIG. 1a shows typical results of the hydrodynamic radius distributions of P(MEO₂MA-co-OEGMA) microgels prepared by using different surfactant (SDS) concentrations. As surfactant concentration increases, the particle size decreases. Hydrodynamic radius distributions of a typical PNIPAM microgel and the P(MEO₂MA-co-OEGMA(475)) microgel (batch 5) in water are compared in FIG. 1b. The size distribution of P(MEO₂MA-co-OEGMA(475)) microgels with the polydispersity index (PDI) of 1.007 is even narrower than that of the PNIPAM microgels with the PDI of 1.08. The complete sample information including chemical composition, surfactant concentration, average hydrodynamic radius Rₕ, and PDI of MEO₂MA and OEGMA microgels is summarized in Table 1. In general, it is more difficult to prepare monodisperse microgels as the monomer molecular weight becomes larger. The molecular weights of both MEO₂MA and oligor(OEGMA) are heavier than NIPAM monomer but the microgels of P(MEO₂MA-co-OEGMA) have a narrow size distribution at least comparable to the PNIPAM microgels. This suggests that the monomer units of “MEO₂MA-OEGMA” were more hydrophobic than that of NIPAM monomer at 70° C., and were packed more densely than the NIPAM.

TABLE 1
Summary of chemical composition, surfactant concentration, average hydrodynamic
radius Rₕ, and PDI of P(MEO₂MA-co-OEGMA) microgels.

| | | OEGMA | OEGMA | | | | |
|---|---|---|---|---|---|---|---|
| Batch | MEO₂MA | (475) | (300) | EGDMA | SDS | Size(nm) | PD.I |
| 1 | | 0.0162 mol | | 4.6 × 10₋₄ mol | 0.04 g | 90 | 1.031 |
| 2 | | 0.0162 mol | 0.0018 mol | 4.6 × 10⁻⁴ mol | 0.04 g | 121 | 1.028 |
| 3 | | 0.0162 mol | 0.0042 mol | 4.6 × 10⁻⁴ mol | 0.04 g | 132 | 1.071 |
| 4 | | 0.0162 mol | 0.0018 mol | 4.6 × 10⁻⁴ mol | 0 g | 412 | 1.007 |
| 5 | | 0.0162 mol | 0.0018 mol | 4.6 × 10⁻⁴ mol | 0.02 g | 151 | 1.007 |
| 6 | | 0.0162 mol | 0.0018 mol | 4.6 × 10⁻⁴ mol | 0.06 g | 102 | 1.005 |
| 7 | | 0.0162 mol | 0.0018 mol | 4.6 × 10⁻⁴ mol | 0.08 g | 82 | 1.005 |
| 8 | | 0.0162 mol | 0.0018 mol | 4.6 × 10⁻⁴ mol | 0.04 g | 113 | 1.009 |

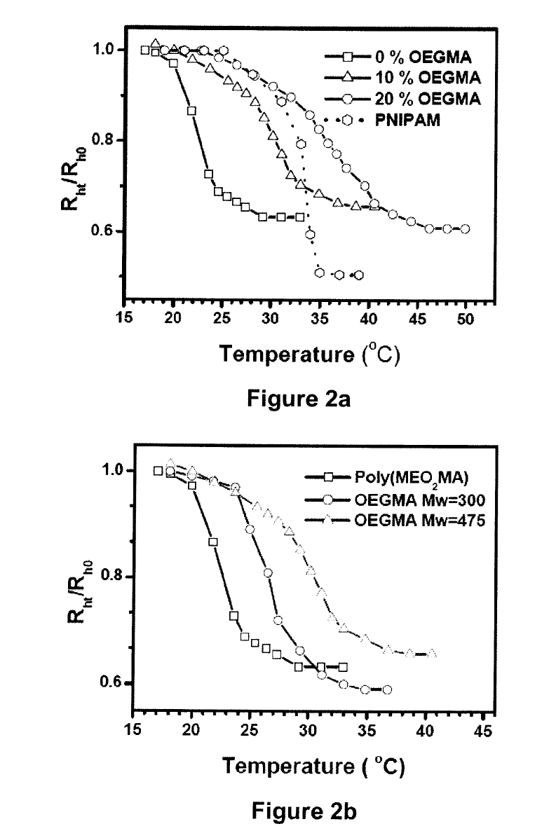

Temperature dependence of normalized hydrodynamic radii (Rₕ) of P(MEO₂MA-co-OEGMA(475)) microgels with three different molar ratios of OEGMA to MEO₂MA is shown in FIG. 2a. Here the radii are divided by the values at 18° C. and the molecular weight of OEGMA is fixed at 475 Dal. The pure MEO₂MA microgel has a LCST of about 22° C. The LCSTs corresponding to the molar ratio at 10 and 20% are 31 and 37° C., respectively. The increase of the LCST with the OEGMA to MEO₂MA molar ratio for our microgels is similar to the previous report for MEO₂MA-co-OEGMA polymer.[11] The LCST behavior of PNIPAM microgels is also plotted in the same figure (FIG. 2a) for comparison. The transition and the volume change of PNIPAM microgels at the LCST are sharper and larger than those of the P(MEO₂MA-co-OEGMA) microgels. The LCST can be also tuned by fixing the molar ratio of OEGMA to MEO₂MA at 10% but changing molecular weight of OEGMA. As shown in FIG. 2b, the LCST of the microgel increases with OEGMA's Mw.

### 4. The Formation of Crystalline Structures in Microgel Arrays

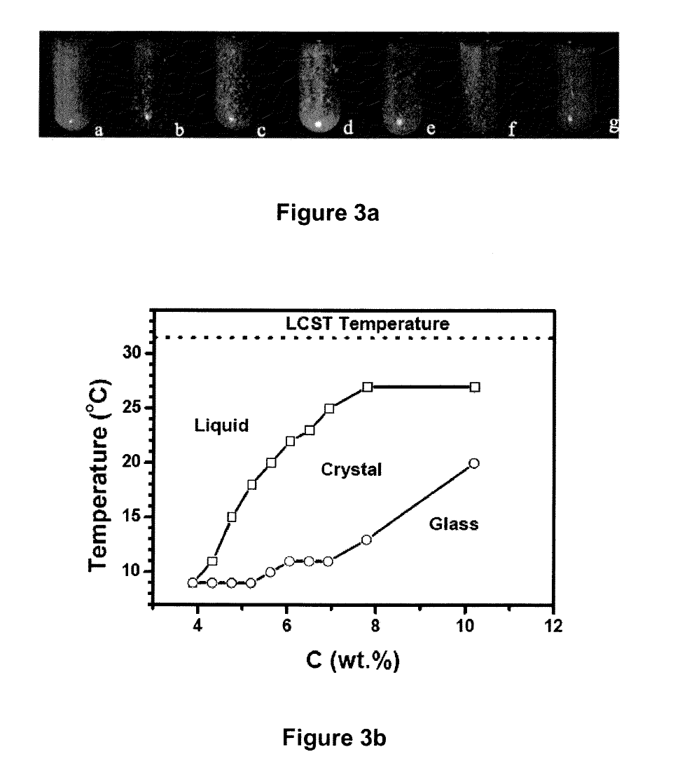

The new microgels have been concentrated using ultracentrifugation with the speed of 13,000 rpm for 4 h. The dispersion of the microgels was then diluted to different polymer concentrations. These dispersions were then shaken with a vibrator and then allowing them to reach an equilibrium state at 18° C. As shown in FIG. 3a, the microgels in these dispersions self-assemble into various phases at 18° C. For polymer concentrations between 4.8 and 10.2 wt %, the microgels form crystal structures with iridescent colors, which are the result of Bragg diffraction from different oriented crystalline planes. Below 4.8 wt %, the microgels in a liquid state are well separated and scatter light randomly so that the dispersion appears turbid. Above 7.8 wt %, there are many microgels in the dispersion. It becomes too viscous so that the microgels don't have freedom to find the lowest energy state of the crystal. As a result, the microgels form a glass state.

This procedure of shaking and then keeping dispersions in a certain temperature was repeated for several temperatures. The results of the phase behavior as functions of both temperature and polymer concentration are summarized in FIG. 3b. Here T_{c} (dashed line) is the LCST of P(MEO₂MA-co-OEGMA(475)) (batch 2) microgels. Tₘ (open squares) is the melting temperature, and T_{g} (open circles) is the glass-transition temperature. As the temperature increases, the particle size decreases. This leads to that a higher polymer concentration is required for microgels to reach a critical volume fraction to form crystals.

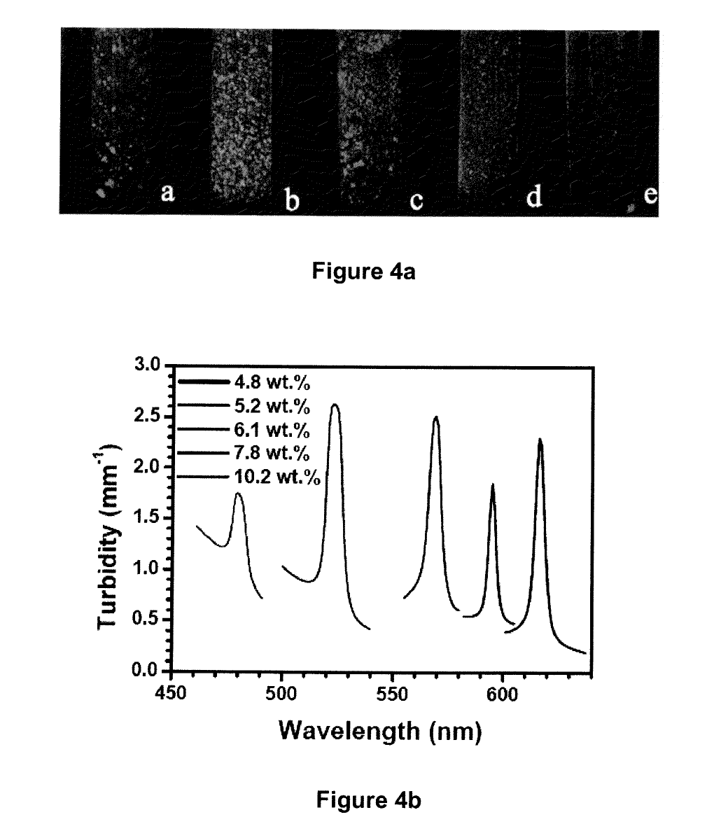

The most interesting phase is the crystalline structure. We have grown the crystal structures with different interparticle distance by first preparing microgel dispersions with different polymer concentrations, then heating these dispersions above their respective melting point and finally letting them to cool down naturally to 18° C. The results are shown in FIG. 4a, where the dispersions with different polymer concentrations show different iridescent colors. Upon the increase of the polymer concentration, the color shifts to blue color. This color change can be also detected using UV-visible spectroscopy. FIG. 4b shows the spectra of the microgel dispersions at various polymer concentrations. The sharp peak is due to Bragg diffraction and shifts from 620 to 480 nm as the polymer concentration increases from 4.8 to 10.2 wt %. This shift is due to the decrease in the interparticle distance with increasing polymer concentration. It is noted that crystallization at 10.2 wt % was obtained. Such a colloidal crystal with high polymer concentration will help to form high mechanical strength hydrogel opals.[21]

### 5. Stabilization of Crystalline Structures

The use of thermal responsive PEG colloidal dispersions based on their crystalline structures is limited because the structures can be easily destroyed by any external disturbance such as small vibrations. Here we show schematics to chemically bond self-assembled PEG microgels. The covalent bonding contributes to the structural stability, while self-assembly provides crystal structures that diffract light, resulting in colors.

### 5.1 Covalent Bond Neighboring Particles Using Polymer Chains

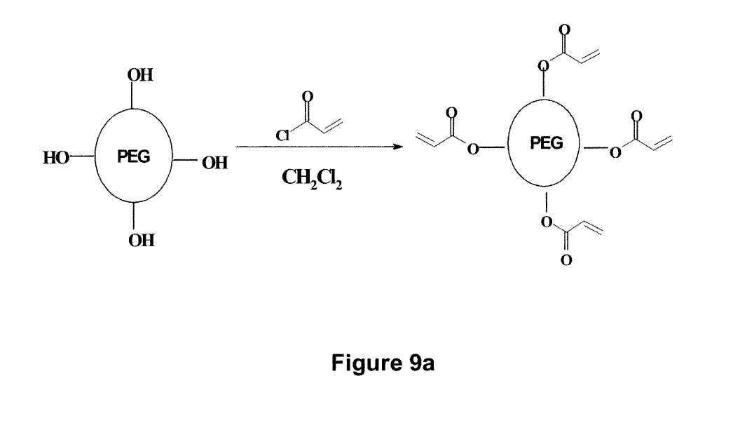

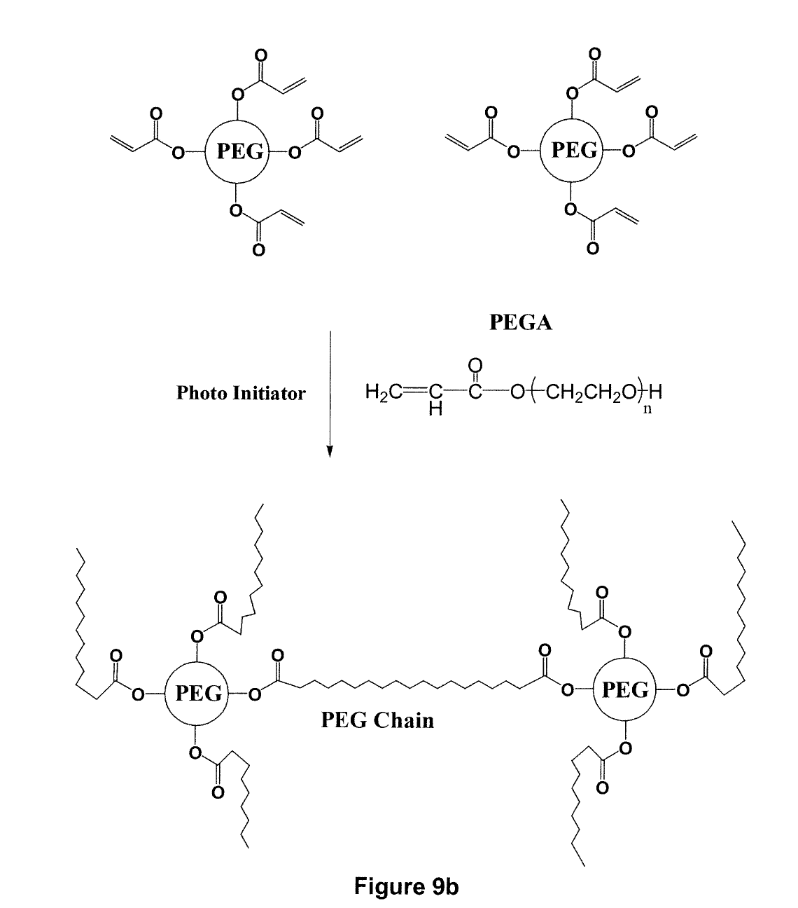

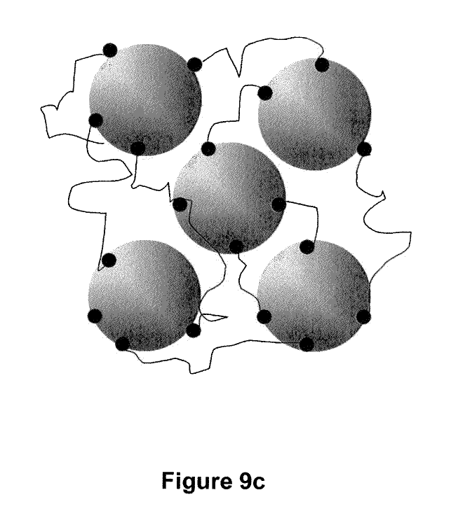

As shown in FIG. 9, first, monodisperse microgels are prepared. Second, these microgels are attached with vinyl groups. Third, connections between microgels are accomplished by using polymer chains (such as polyethylene glycol) to connect vinyl groups between particles. Here particles act as crosslinkers.

Materials. Poly(ethylene glycol)ethyl ether methacrylate (PEGETH₂MA, Mₙ˜246 g poly(ethylene glycol) methyl ether methacrylate (PEGEMAPEGMEA, Mₙ˜300 g poly(ethylene glycol) acrylate (PEGA, Mₙ˜375 g mol⁻¹), acryloyl chloride, dodecyl sulfate sodium salt 98% (SDS), and potassium persulfate (KPS) were purchased from Aldrich. Ethylene glycol dimethacrylate (EGDMA 97%) was purchased from Fluka. All chemicals were used as received.

PEGETH₂MA-co-PEGMA-co-PEGA Microgel Preparation. The copolymerization of PEGETH₂MA, PEGMAPEGMEA and PEGAAPEGA was carried out in a three-necked flask equipped with stirrer and a nitrogen feed. 5.63 g of PEGETH₂MA(Mₙ˜246 g mol⁻¹), 1.72 g PEGMEA (Mₙ˜300 g mol⁻¹), 1.07 g PEGAAPEGA (Mₙ˜375 g mol⁻¹), 0.064 g SDS and 4.6×10⁻⁴ mol of EGDMA were dissolved in 400 ml of DI water. The solution was purged with nitrogen gas for 40 min at 70° C. Ammonium persulfate (0.20 g), which was dissolved in 5 mL of water, was then added to initiate the emulsion copolymerization. The reaction lasted for 12 hours under the nitrogen atmosphere. The reaction temperature was kept at 70° C. Then the microgels were purified via a dialysis tube (MWCO13 000) against frequent changes of stirring water for 1 week at room temperature. The microgels were collected by ultra centrifugation.

Vinyl thermo-responsive PEG based microgel preparation. The collected PEGETH₂MA-PEGMAPEGMEA-co-PEGA microgel 10 g (10 wt. %) were dried by freeze-dry method. Then the microgels were re-dispersed in 100 ml CH₂Cl₂. 1 g acryloyl chloride and trace amount tri-ethylamine (compared with acryloyl chloride) were slowly added into microgels solution. The molar ratio between acrylate PEG (OH group) to acryloyl chloride was 1 to 32. The reaction was carried out under dark at room temperature with anhydrous environment for 24 hours. The reaction in darkness was just precaution for protecting the vinyl group. The reaction was stopped by adding 300 ml absolute ethyl alcohol. The vinyl-PEG based microgels were collected by ultra centrifugation. Then the vinyl microgels were dispersed in ethyl alcohol and put into a dialysis tube under dark for a week in absolute ethyl alcohol, 50 vol. % ethyl alcohol, 25 vol. % ethyl alcohol and DI water at temperature 4° C. Vinyl group was confirmed by IR spectra.

### Photonic Crystal Gel Preparations

Vinyl PEG based microgel/PEG acrylate (PEGA, Mₙ˜375 g mol⁻¹) crystalline hydrogel film preparation. 0.45 g 20 wt. % PEG acrylate with UV initiator 2-hydroxy-1-[4-(2-hydroxyothoxy)phenyl]-2-methyl-1-propanone (CIBA) (0.2 wt %), 0.55 g 12 wt. % vinyl PEG microgel were mixed. The suspension was de-oxygen by freeze-thaw method. The suspension was injected into a cell consisting of two clean quartz disks separated a 125 μm Parafilm film. The crystalline structures were formed by slowly changing temperature from 29° C. to 4° C. in 24 hours. If this change was too rapidly, there would be no crystallization. The crystalline structure was then stabilized by UV irradiation triggered free radical polymerization at 0° C. for 30 min. All chemicals were used as received. The resultant hydrogels was washed out with DI water that was changed twice a day for 10 days to clean monomer and un-reacted small molecules.

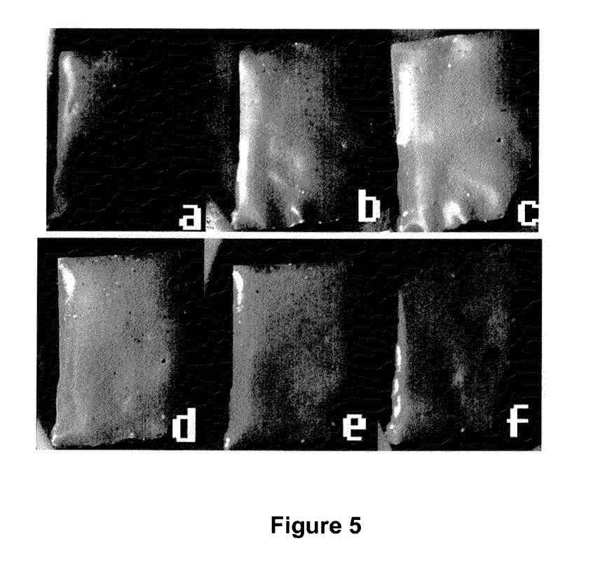

FIG. 5 shows a typical picture of a hydrogel thin film that P(MEO₂MA-co-OEGMA) microgels were trapped into a polyacrylamide hydrogel matrix. This film is flexible and fully swells in water but has iridescent colors from ordered P(MEO₂MA-co-OEGMA) microgels arrays.

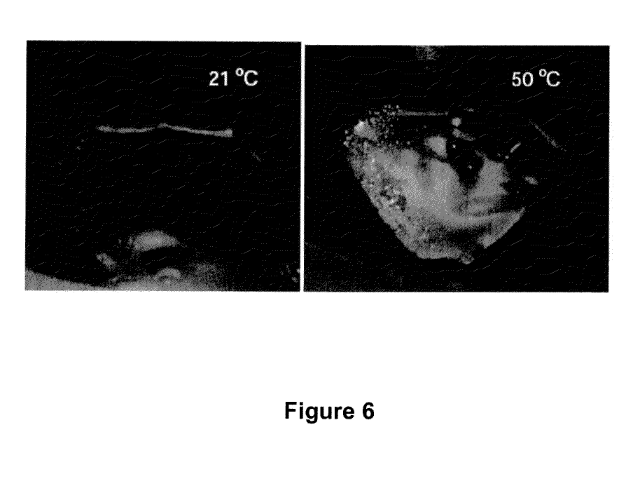

Because the building blocks here are environmentally responsive colloidal spheres, their sizes as well as the lattice spacing should be tunable by external stimuli. As a result, the crystalline hydrogel can serve as an optical sensor to visually inspect environmental changes. One of the examples is shown in FIG. 6. The crystalline hydrogel at 21° C. displays a bright red color but changes from red to green at 50° C. When the temperature is decreased to room temperature again, the gel restored its color and volume. This process is fully reversible.

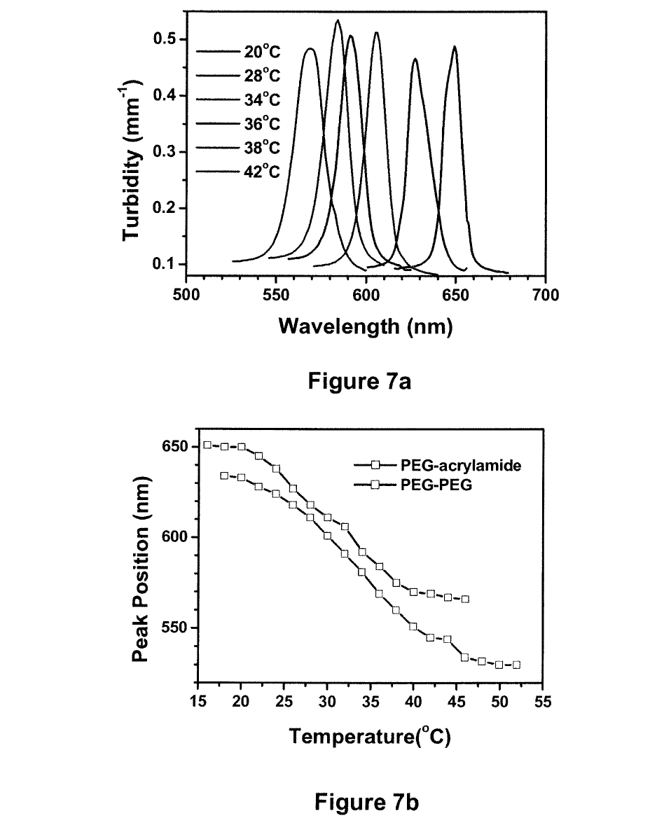

It has been already established that colors of microgel dispersions are related to the Bragg diffraction from periodic arrays of microgels, which is shown as a peak in UV-visible spectrum in FIG. 7a. It is noted as the temperature increases from room temperature for a crystalline hydrogel consisting of a cross-linked microgels array, the wavelength of the peak changes significantly. Specifically, the wavelength of the Bragg peak decreases from about 652 to 565 nm upon the increase of the temperature from 20 to 42° C. as shown in FIG. 7b. The change of the peak wavelength is due to the shrinkage of particle size with the temperature, which causes the decrease of inter-particle spacing in crystalline hydrogels.

5.2 Entrapping Microgels into Another Hydrogel Matrix

Firstly monodisperse microgels were prepared. Random copolymers of 2-(2-methoxyethoxy)ethylmethacrylate (MEO₂MA) and oligo (ethylene glycol) methacrylate (OMGMA or O300 Mn=300) exhibited LCST 37° C. with mole ratio=1:1. 1.98 g MEO₂MA, 3.06 g O300, 0.035 g sodium dodecyl sulfate (SDS, work as surfactant), 0.10 g ethylene glycol dimethacrylate (EGDMA M=198, 2.45% of monomer work as the cross-linker) and 0.18 g acrylic acid (AA) were mixed together in a reactor. 195 g deionized water are added and bubbled with nitrogen for 40 min at 70° C. Then a solution of 0.16 g potassium persulfate in 5 g deionized water was added to initiate the reaction. The reaction was carried out at 70° C. for 4 hours. The resulting particle dispersions were dialyzed for 7 days to remove small molecules and surfactant. Then the particle dispersions were concentrated with centrifuging at 14000 rpm. Solid percentage in microgels was 11 wt %.

Second, these microgels were entrapped into a polymer network, a hydrogel (such as polyacrylamide or PEG with cross-linker). 4.66 g sample above and 0.25 g acrylamide, 0.19 g photo initiator (0.1% 2-hydroxyl-1-[4-(2-hydroxy ethoxy)phenyl]-2-methyl propanone water solution) and 0.005 g BIS (methylenebisacrylamide) were mixed and bubbled with nitrogen for 40 min. Then the sample was handled under nitrogen protection and exposed under ultra violet light for 30 min.

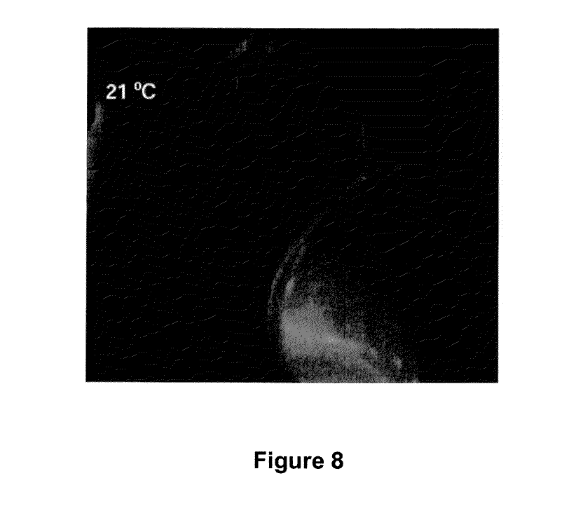

FIG. 8 shows a typical hydrogel thin film that P(MEO₂MA-co-OEGMA) microgels were trapped into a PEG hydrogel matrix. Here 6 wt % particles S2 and 16 wt % PEG methacrylate (Mn=360) monomer and 1% glycerol 1,3 diglycerolate diarylate as crosslinker were mixed in water. The particles S2 was prepared with MEO₂MA 3.21 g, AA 0.13 g, OEGMA(246) 0.44 g, and EGDMA 019 g. The particle radius measured by dynamic light scattering was about 160 nm.

In summary, the P(MEO₂MA-co-OEGMA) microgels have been synthesized by using free radical polymerization. The microgels with a variety of particle radii ranging from 82 nm to 412 nm have been obtained with different surfactant concentrations. As surfactant concentration increases, the particle size decreases. The particle size distribution is extremely narrow and even better than PNIPAM microgels. The pure MEO₂MA microgel has the LCST about 22° C. The LCST corresponding to the molar ratio of OEGMA to MEO₂MA at 10 and 20% are 31 and 37° C., respectively. The LCST can be also tuned by fixing the molar ratio of OEGMA to MEO₂MA at 10% but changing molecular weight of OEGMA. The microgels in water self-assemble into various phases including a crystalline with iridescent colors, which are the result of Bragg diffraction from different oriented crystalline planes. The UV-visible spectra from microgel dispersions show that the sharp Bragg peak from 620 to 480 nm as the polymer concentration increases from 4.8 to 10.2 wt %. This crystalline structure was fully stabilized by either trapping microgels into a hydrogel matrix or covalently linking neighboring microgels. The thin films of these interlinked microgels have been taken out from the test tubes. UV-visible spectroscopy has been used to monitor the change of the Bragg diffraction form these films as a function of temperature. The change of the peak wavelength is due to the shrinkage of the particle size with the temperature, which causes the decrease of inter-particle spacing in crystalline hydrogels. As a result, the crystalline hydrogel may serve as an optical sensor to visually inspect environmental changes.

### REFERENCES CITED

The following references, to the extent that they provide exemplary procedural or other details supplementary to those set forth herein, are specifically incorporated herein by reference.

### REFERENCES

1. Schild, H. G.; Prog. Polym. Sci. 1992, 17 (2), 163.
2. Pelton, R. H.; Chibante, P. Colloids Surf. 1986, 20, 247.
3. Hirotsu, Y.; Hirokawa, T.; Tanaka, T. J. Chem. Phys. 1987, 87, 1392.
4. Hoffman, A. S. J. Controlled Release, 1987, 6, 297.
5. Bae, Y. H.; Okano, T.; Hsu, R.;. Kim, S. W. Makromol. Chem., Rapid Commun, 1987, 8, 481.
6. Brazel, C. S.; Peppas, N. A. J. Controlled Release, 1996, 39, 57.
7. Wang, C.; Stewart, R. J.; Kopecek, J. Nature, 1999, 397, 417.
8. Misraa, G. P.; Siegel, R. A. J. Controlled Release, 2002, 81, 1.
9. Ito, T.; Yamaguchi, T. Angew. Chem. Int. Ed, 2006, 45, 5630.
10. Harsh, D. C.; Gehrke, S. H. J. Controlled Release, 1991, 17, 175.
11. Lutz, J.-F.; Akdemir, Ö.; Hoth, A. J. Am. Chem. Soc. 2006, 128, 13046.
12. Lutz, J.-F.; Hoth, A. Macromolecules 2006, 39, 893.
13. Lutz, J.-F.; Weichenhan, K.; Akdemir, Ö.; Hoth, A. Macromolecules 2007, 40, 2503.
14. Weissman, J. M.; Sunkara, H. B.; Tse, A. S.; Asher, S. A. Science, 1996, 274, 959.
15. Senff, H.; Richtering, W.; J. Chem. Phys. 1999, 111, 1705
16. Debord, J. D.; Lyon, L. A. J. Phys. Chem. 2000, 104, 6327.
17. Hu, Z. B.; Lu, X. H.; Gao, J.; Wang, C. J. Adv. Mater. 2000, 12, 1173
18. Hu, Z. B.; Lu, X. H.; Gao, J. Adv. Mater. 2001, 13, 1708
19. Duncan, R. Nat. Rev. Drug Discovery 2003, 2, 347.
20. Greenwald, R. B.; Choe, Y. H.; McGuire, J.; Conover, C. D. Adv Drug Deliv. Rev. 2003, 55, 217.
21. Hu, Z. B.; Huang, G. Angew. Chemie, Int. Ed, 2003, 42, 4799.

What is claimed is:

1. Monodisperse, thermo-responsive microgels, prepared using a method comprising the steps of:
a) dissolving MEO₂MA, OEGMA, a crosslinker, and a surfactant in deionized water to give a first solution;
b) purging the first solution with nitrogen gas for about 40 minutes at about 70° C.;
c) adding potassium persulfate dissolved in water to the first solution to give a second solution;
d) allowing the second solution to react for about 6 hours under a nitrogen atmosphere at about 70° C. to give a third solution;
e) purifying the third solution using dialysis against water for about one week at about room temperature; and
ultracentrifuging the third solution to collect the monodisperse microgels.

2. The monodisperse, thermo-responsive microgels of claim 1, wherein the average hydrodynamic radius is between about 50 nm and about 400 nm.

3. The monodisperse, thermo-responsive microgels of claim 1, wherein the radius distribution function is between about 1.0007 and about 1.08.

4. The monodisperse, thermo-responsive microgels of claim 1, wherein the adjustable volume phase transition temperatures in an aqueous environment range from about 19° C. to about 90° C.

5. The monodisperse, thermo-responsive microgels of claim 1, further comprising polyacrylic acid (PAA).

6. The monodisperse, thermo-responsive microgels in claim 1, wherein the microgels are capable of forming a crystalline structure in water in the polymer concentrations ranging from 5.8 wt % to 11 wt % at 20° C.

7. The monodisperse, thermo-responsive microgels in claim 1, wherein the microgels are capable of acting as crosslinkers to connect poly(ethylene glycol) chains.

8. A method for preparing monodisperse, thermo-responsive microgels comprising the steps of:
a) dissolving MEO₂MA, OEGMA, a crosslinker, and a surfactant in deionized water to give a first solution;
b) purging the first solution with nitrogen gas for about 40 minutes at about 70° C.;
c) adding potassium persulfate dissolved in water to the first solution to give a second solution;
d) allowing the second solution to react for about 6 hours under a nitrogen atmosphere at about 70° C. to give a third solution;
e) purifying the third solution using dialysis against water for about one week at about room temperature; and
f) ultracentrifuging the third solution to collect the monodisperse microgels.

9. The method of claim 8, wherein 0.016 mol of MEO₂MA are added.

10. The method of claim 8, wherein the OEGMA is at a concentration of between about 0.0016 mol and about 0.016 mol.

11. The method of claim 8, wherein the crosslinker is EGDMA, Glycerol, or 1,3-diglycerolate diacrylate.

12. The method of claim 8, wherein range from 0 to 4.6×10⁻⁴ mol of crosslinker is added.

13. The method of claim 8, wherein the surfactant is SDS.

14. The method of claim 8, wherein the SDS is at a concentration of between about 0 wt % and about 0.1 g wt %.

15. The method of claim 8, wherein 245 g of deionized water is used to give the first solution.

16. The method of claim 8, wherein 0.10 g potassium persulfate is added.

17. The method of claim 8, wherein the membrane used for dialysis has a molecular weight cut-off of about 13,000.

18. The method of claim 8, wherein the reaction is carried out in a 3-necked flask.

19. The method of claim 8, wherein the ultracentrifugation is carried out from 5,000 rpm to 25,000 rpm for several hours.

20. A method for preparing monodisperse, thermo-responsive microgels comprising the steps of:
a) 0.016 mol of additive and 0 to 4.6×10⁻⁴ mol EGDMA, glycerol, or GDD, and SDS in 245 g deionized water to give a first solution;
b) purging the first solution with nitrogen gas for about 40 minutes at about 70° C. to give a second solution;
c) adding 0.10 g ammonium persulfate dissolved in 5 ml water to form a third solution;
d) allowing the third solution to react for about 12 hours under a nitrogen atmosphere at about 70° C. to form a fourth solution;
e) purifying the fourth solution using dialysis against water for about one week at about room temperature to form a fifth solution; and
f) ultracentrifuging the fifth solution to collect the monodisperse microgels w/additive.

21. The method of claim 20, wherein the additive is selected from the group consisting of OEGMA (246) and OEGMA(300) and PEGA(375).

22. A method of adding a functional group to microgels, comprising the steps of:
a) freeze-drying 10 g of 10 wt % the monodisperse, thermo-responsive microgels of claim 20;
b) redispersing the microgels in 150 ml dried CH₂CL₂ under a nitrogen atmosphere to form a first solution;
c) adding 2 g of acryloyl chloride to the first solution to give a second solution;
d) stirring the second solution for about 24 h;
e) adding 150 ml ethyl alcohol to the second solution to give a third solution;
f) centrifuging the third solution to collect the microgels;
g) purifying the third solution using dialysis against water to form a fourth solution; and
h) centrifuging the fourth solution to give a desired wt % of microgels.

23. The method of claim 22, wherein the functional group is vinyl.

24. A method for producing hydrogel films, comprising the steps of:
a) adding a UV initiator and 6 wt % of acrylamide or vinyl PEG-375 to the vinyl microgel preparation of claim 23 to give a fifth solution;
b) purging the fifth solution with nitrogen gas for about 60 minutes;
c) maintaining the fifth solution at 10° C. for about 24 hours; and
d) stabilizing the fifth solution using UV irradiation triggered free radical polymerization at approximately 0° C. for approximately 20 minutes.

25. The method of claim 24, wherein the UV initiator is 2-hydroxy-1-[4-(2-hydrxyothoxy)phenyl]-2-methyl-1-propanone, and is added at a concentration of 0.03 wt %.
